(19) United States
(12) Patent Application Publication
(10) Pub. No.: US 2014/0372929 A1
(43) Pub. Date: Dec. 18, 2014

(54) APPARATUS AND METHOD FOR PROVIDING USER INTERFACE REGARDING AERONAUTICAL SYSTEM CONFIGURATION

(71) Applicant: ELECTRONICS AND TELECOMMUNICATIONS RESEARCH INSTITUTE, Daejeon-city (KR)

(72) Inventors: Sa-Choun Park, Gunpo-si (KR); Tae-Ho Kim, Gunpo-si (KR)

(21) Appl. No.: 14/302,755

(22) Filed: Jun. 12, 2014

(30) Foreign Application Priority Data
Jun. 14, 2013 (KR) 10-2013-0068354

(51) Int. Cl. G06F 3/0484

(52) U.S. Cl. CPC G06F 3/0484
USPC 715/771

(57) ABSTRACT

Disclosed herein is an apparatus for providing a user interface used to input the configuration values of an aeronautical system. The apparatus includes a software architecture unit for receiving or checking the attributes of software applied to the aeronautical system, a hardware architecture unit for providing a hardware design model that is a base for the operation of the software, a scheduling unit for receiving information about the scheduling of partition information that belongs to the configuration values and transforming the scheduling information in a specific form, a memory unit for storing the attributes of the software, a health monitoring unit for configuring health monitoring based on the software architecture unit, and a connection unit for receiving connection information regarding that partitions are connected to which channel.

### CROSS-REFERENCE TO RELATED APPLICATION

This application claims the benefit of Korean Patent Application No. 10-2013-0068354, filed on Jun. 14, 2013, which is hereby incorporated by reference in its entirety into this application.

### BACKGROUND OF THE INVENTION

1. Field of the Invention

The present invention relates to an apparatus and method for providing a user interface regarding an aeronautical system configuration and, more particularly, to an apparatus and method for providing a user interface in a cube form in which an aeronautical system configuration method can be easily understood by an integrator and a software developer.

2. Description of the Related Art

Current aeronautical software is being developed based on Integrated Modular Avionics (IMA). A conventional federated system uses each processor in order to drive application software. In contrast, the IMA is a platform concept in which one high-performance processor drives multiple application programs having different safety.

In order to drive multiple application programs in one processor as described above, safety needs to be fundamentally provided in a platform level. A partitioning concept has emerged through a standard, such as Aeronautical Radio, Incorporated (ARINC) 653, under the necessity.

The partitioning concept is made up of the partitioning of the space and time, which means that application programs need to be scheduled along with memory resources without the intervention of other application programs, that is, safely. Information about the configuration of IMA-based software including information about the scheduling with such memory resources is called a configuration.

An embedded system is commonly applied to industrial fields that require high safety, such as aviation, vehicles, and atomic energy. As computing capabilities are recently increased, requirements for embedded software have been greatly increased, which has resulted in an increase in the complexity of a system. Accordingly, model-based development methodology has been in the spotlight as an alternative for ensuring the safety of a complicated system.

A model-based development trend for a current embedded system is an authentication system. The International Organization for Standardization (ISO) 26262 standard in the vehicle fields or standards, such as DO-178C, in the aviation fields hint that the model-based development methodology and tools therefor will be used to develop a software system.

The model-based development methodology means a method capable of systematically managing the entire project from the early stage of development by deriving source code from a model and testing the source code. When the method was first suggested, a process of deriving source code from a model was very ambiguous, but this method has been gradually seated in the industrial world and has been developed in a practical form. There are still examples in which software is written using only source code, but in most cases, software is written under help from a modeling tool.

As the model-based development method is applied to the development of an embedded system whose safety is important as described above, in particular, to the development of IMA-based aeronautical software, a system configuration is inevitably based on a model.

In order to record data on a device specific to aviation more conveniently, Korean Patent Application Publication No. 2012-0033604 discloses an “Interface Apparatus for Flight Recorder” technique.

However, Korean Patent Application Publication No. 2012-0033604 discloses only the interface apparatus for a flight recorder which can record video data in addition to audio data, but does not disclose a user interface in which a complicated IMA-based software system can be conveniently configured from an integrator' viewpoint.

Accordingly, there is an urgent need for a user interface technique capable of conveniently configuring a complicated IMA-based software system from an integrator and software developer's viewpoint.

### SUMMARY OF THE INVENTION

An object of the present invention is to provide an apparatus and method for providing a user interface in a cube form in which an aeronautical system configuration method can be easily understood by an integrator and a software developer.

In accordance with an aspect of the present invention, there is provided an apparatus for providing a user interface used to input the configuration values of an aeronautical system regarding an aeronautical system configuration, including a software architecture unit configured to receive or check the attributes of software applied to the aeronautical system, a hardware architecture unit configured to provide a hardware design model that is a base for the operation of the software, the scheduling unit configured to receive information about the scheduling of partition information that belongs to the configuration values and transform the scheduling information in a specific form, a memory unit configured to store the attributes of the software, a health monitoring unit configured to configure health monitoring based on the software architecture unit, and a connection unit configured to receive connection information regarding that partitions are connected to which channel, wherein the software architecture unit, the hardware architecture unit, the scheduling unit, the memory unit, the health monitoring unit, and the connection unit are applied to respective six faces included in a cube.

The apparatus for providing a user interface regarding an aeronautical system configuration may input configuration values included in an Aeronautical Radio, Incorporated (ARINC) 653 standard.

The software architecture unit distinguishes a specific partition when a user selects the specific partition through a touch or click.

Faces other than a face corresponding to the software architecture unit change corresponding configuration values in accordance with the specific partition.

In accordance with an aspect of the present invention, there is provided a method of providing a user interface used to input configuration values of an aeronautical system regarding an aeronautical system configuration, including receiving or checking, by a software architecture unit, the attributes of software applied to the aeronautical system, providing, by a hardware architecture unit, a hardware design model that is a base for the operation of the software, receiving, by the scheduling unit, information about the scheduling of partition information that belongs to the configuration values and transforming the scheduling information in a specific form, storing, by a memory unit, the attributes of the software, configuring, by a health monitoring unit, health monitoring based on the software architecture unit, and receiving, by a connection unit, connection information regarding that partitions are connected to which channel, wherein the user interface is provided by applying the software architecture unit, the hardware architecture unit, the scheduling unit, the memory unit, the health monitoring unit, and the connection unit are applied to respective six faces included in a cube.

Configuration values included in an Aeronautical Radio, Incorporated (ARINC) 653 standard may be inputted.

In the receiving or checking of the attributes of the software, a specific partition is distinguished when a user selects the specific partition by touching or clicking on a face corresponding to the software architecture unit in the cube.

Faces other than a face corresponding to the software architecture unit change corresponding configuration values in accordance with the specific partition.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram schematically showing an apparatus for providing a user interface regarding an aeronautical system configuration in accordance with an embodiment of the present invention.

FIG. 2 is a diagram showing a user interface apparatus when a user selects an operating system in the aeronautical system configuration in accordance with an embodiment of the present invention.

FIG. 3 is a diagram showing the user interface apparatus when a user selects an application program in the aeronautical system configuration in accordance with an embodiment of the present invention.

FIG. 4 is a flowchart illustrating a method of providing a user interface regarding the aeronautical system configuration in accordance with an embodiment of the present invention.

### DESCRIPTION OF THE PREFERRED EMBODIMENTS

Hereafter, the present invention is described in detail with reference to the accompanying drawings. Repeated descriptions and descriptions of known functions and constructions which are deemed to make the gist of the present invention unnecessarily vague are omitted below. The embodiments of the present invention are provided in order to fully describe the present invention to those skilled in the art. Accordingly, the shapes, sizes, etc. of elements in the drawings may be enlarged for clarity of description.

An apparatus and method for providing a user interface regarding an aeronautical system configuration in accordance with exemplary embodiments of the present invention are described in detail below with reference to the accompanying drawings.

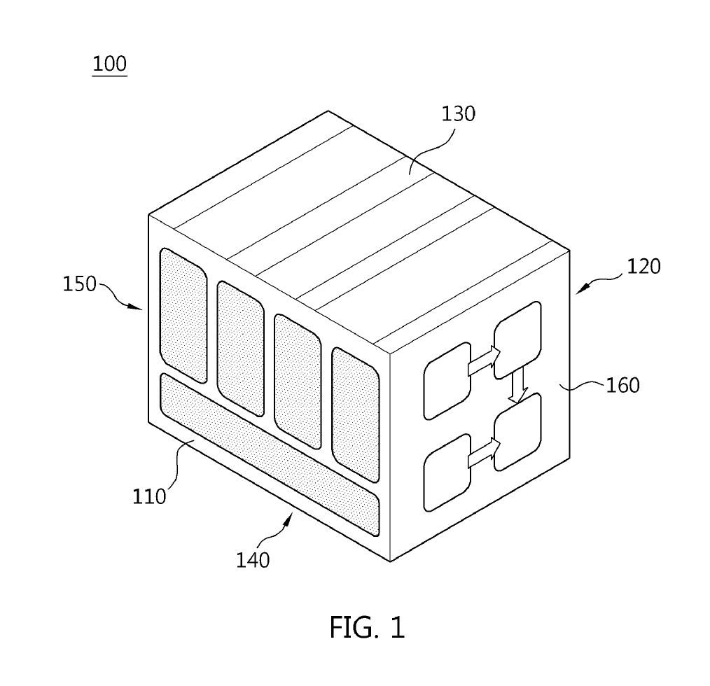

FIG. 1 is a diagram schematically showing an apparatus for providing a user interface regarding an aeronautical system configuration in accordance with an embodiment of the present invention.

First, configuration values included in the ARINC 653 standard include system health monitoring, module health monitoring, partition health monitoring, partition information, memory information, scheduling information, and connection information.

More particularly, contents regarding a health monitor for error processing are defined in three layers, such as health monitoring, module health monitoring, and partition health monitoring.

The partition information includes a port and a process that are used for a partition to perform communication. The port includes a sampling port type and a cueing port type. Furthermore, the process is used as the same concept as the thread of a program, and in this process, only a name and a stack size are simply inputted in a standard document.

The memory information includes attributes, such as a type, a size, an address, and access rights, and may describe that which partition is used.

The scheduling information corresponds to information about the scheduling of partition information.

The connection information defines that the port of which partition and the port of which partition form a channel.

In the ARINC 653 standard, an XML-schema is defined. However, XML is disadvantageous in that it needs to have information redundantly because it basically has a tree form and the entire configuration situation may not be understood clearly.

For this reason, a user interface is necessary to input and manage the configuration values of a system to which specific software, such as aeronautical software, has been applied.

The present invention relates to an apparatus for providing a user interface that is used to input the configuration values of a system to which aeronautical software has been applied (hereinafter referred to as a “user interface providing apparatus regarding an aeronautical system configuration”). Here, the configuration values correspond to information about the configuration of IMA-based software including information about scheduling with memory resources.

The user interface providing apparatus 100 regarding an aeronautical system configuration in accordance with an embodiment of the present invention has a cube form as shown in FIG. 1.

Referring to FIG. 1, the user interface providing apparatus 100 regarding an aeronautical system configuration includes a software architecture unit 110 that is the center, a hardware architecture unit 120, a scheduling unit 130, a memory unit 140, and a health monitoring unit 150 based on corresponding software, and a connection unit 160 related to communication.

The software architecture unit 110, the hardware architecture unit 120, the scheduling unit 130, the memory unit 140, the health monitoring unit 150, and the connection unit 160 are disposed in the respective faces of a cube.

The three-dimensional user interface providing apparatus having a curb form in accordance with an embodiment of the present invention may be applied to all desktop environments in which manipulation is performed using a touchable mobile device or mouse.

If the model-based development method is updated, an integrator may naturally accept that a configuration is changed using the user interface of the cube form through a mobile device and configured situations are recognized.

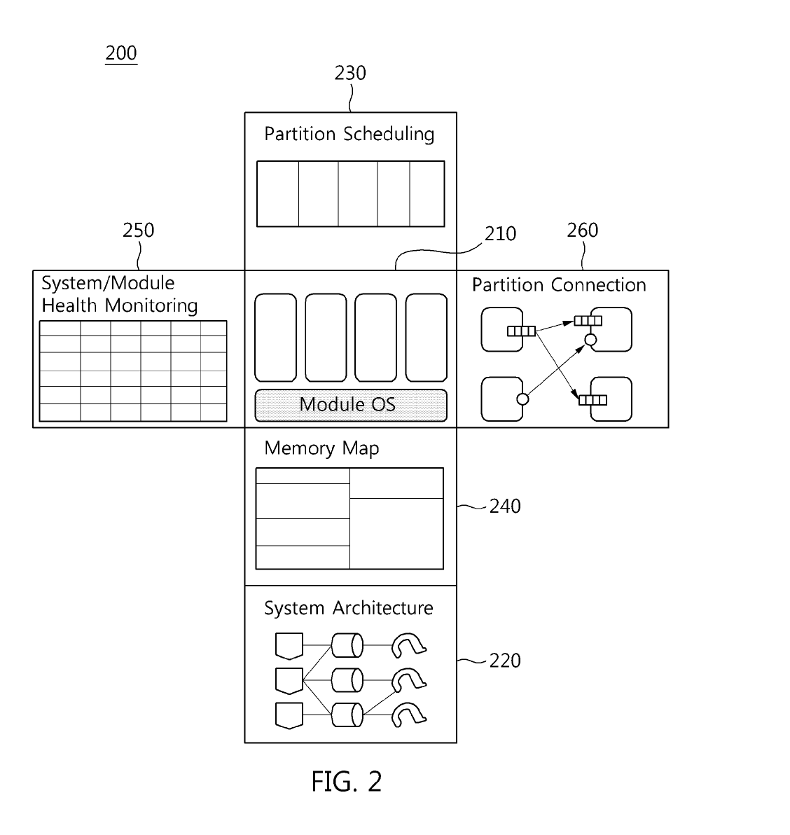

An example of the user interface providing apparatus when a user selects an Operating System (OS) in an aeronautical system configuration is described in detail with reference to FIG. 2.

FIG. 2 is a diagram showing a user interface apparatus when a user selects an OS in the aeronautical system configuration in accordance with an embodiment of the present invention.

Referring to FIG. 2, a user interface regarding an aeronautical system configuration in accordance with an embodiment of the present invention may have a form in which configuration values included in the ARINC 653 standard are received, but the present invention is not limited thereto.

A face 210 corresponding to the software architecture unit (110 of FIG. 1) may receive or check the basic attributes (e.g., corresponding to a name and an ID) of a module OS.

The hardware architecture unit (120 of FIG. 1) is a system architecture and is a hardware architecture, that is, a base for the operation of corresponding software. A face 220 corresponding to the hardware architecture unit (120 of FIG. 1) is not directly related to a configuration included in the ARINC 653 standard, but may show a hardware design model used in hardware/software-simultaneous designs and tests (e.g., simulations and pattern verification).

A face 230 corresponding to the scheduling unit (130 of FIG. 1) receives information about the scheduling of partition information that belongs to the configuration values included in the ARINC 653 standard and transforms the received information in a specific form that may be easily understood. Here, the scheduling information corresponds to information about the scheduling of partition information.

That is, the face 230 corresponding to the scheduling unit (130 of FIG. 1) does not list numbers corresponding to scheduling information, but may visualize and show the duration of each piece of partition information in width.

A face 240 corresponding to the memory unit (140 of FIG. 1) shows that the elements of the software architecture unit 210, that is, the configurations of a module OS and partitions and the basic attributes of the partitions and the module are stored in the memory unit (140 of FIG. 1) in which form. Here, the elements of the software architecture 210 may have number and Graphical User Interface (GUI) forms.

A face 250 corresponding to the health monitoring unit (150 of FIG. 1) is a screen in which health monitoring is configured in a system/module level. Information corresponding to the health monitoring may be inputted or modified in a table form.

A face 260 corresponding to the connection unit (160 of FIG. 1) receives connection information regarding that partitions are connected to which channel and shows the received connection information in a GUI form. A circular form and a square form included in the face 260 corresponding to the connection unit (160 of FIG. 1) do not show a representation method, but mean that partitions may be distinguished and represented depending on the type of port, for example, in a sampling port or a cueing port.

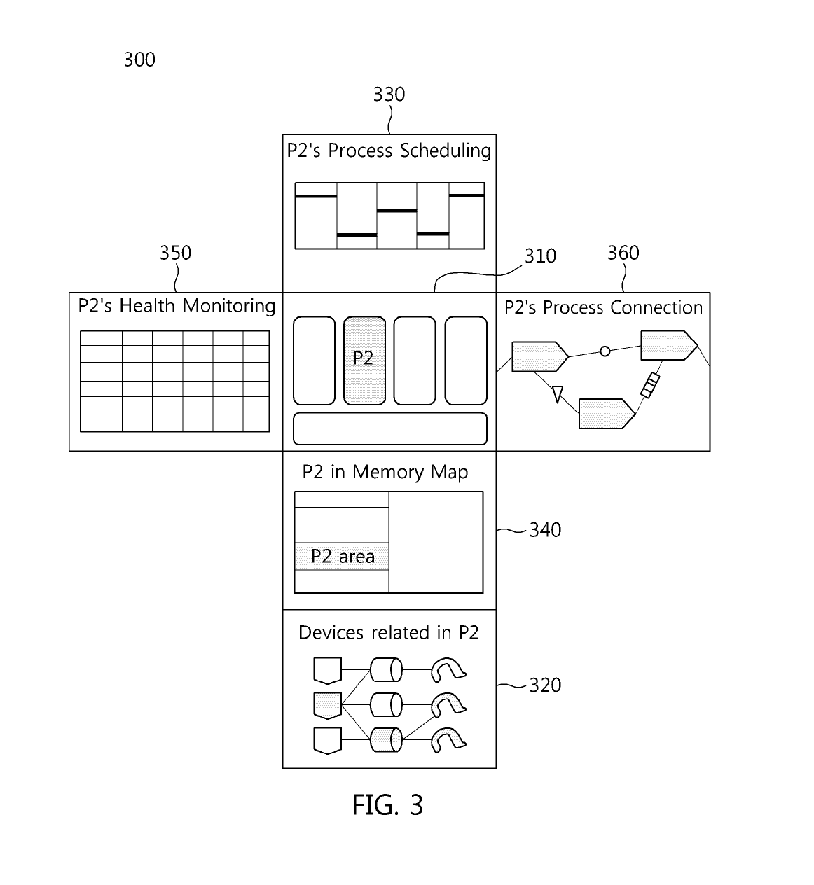

Another example of the user interface providing apparatus when a user selects an application program in the aeronautical system configuration is described in detail below with reference to FIG. 3.

FIG. 3 is a diagram showing the user interface apparatus when a user selects an application program in the aeronautical system configuration in accordance with an embodiment of the present invention.

First, the user interface providing apparatus regarding an aeronautical system configuration shown in FIG. 2 is an interface through which configuration values included in the ARINC 653 standard can be inputted.

In a face 310 corresponding to the software architecture unit (110 of FIG. 1), a specific partition is distinguished when a user selects the specific partition through a touch or click. Here, faces 320 to 360 other than the face 310 corresponding to the software architecture unit (110 of FIG. 1) are changed into a configuration of a level corresponding to the specific partition.

That is, when a partition is selected, the faces 320 to 360 other than the face 310 corresponding to the software architecture unit (110 of FIG. 1) distinguish and show a device connected to the selected partition (i.e., device related in P2), the process schedule of the selected partition (i.e., P2's process scheduling), the area (i.e., P2 area) of the selected partition within a specific map (i.e., P2 in memory map) included in the memory unit (140 of FIG. 1), information corresponding to the health monitoring of the selected partition (i.e., P2's health monitoring), and a connection relation between processes within the selected partition (i.e., P2's process connection).

Here, a configuration value regarding the connection relation between processes within the selected partition (i.e., P2's process connection) has not been described in the ARINC 653 standard, but it includes a language element that may be defined in a model-based language, such as Architecture Analysis & Design Language (AADL).

In general, in the industry, a configuration regarding semaphore, events, and buffers used in a partition is made possible.

Accordingly, the face 360 corresponding to the connection unit (160 of FIG. 1) shows a connection relation between processes within a partition and the flow of the processes using semaphore, events, and buffers.

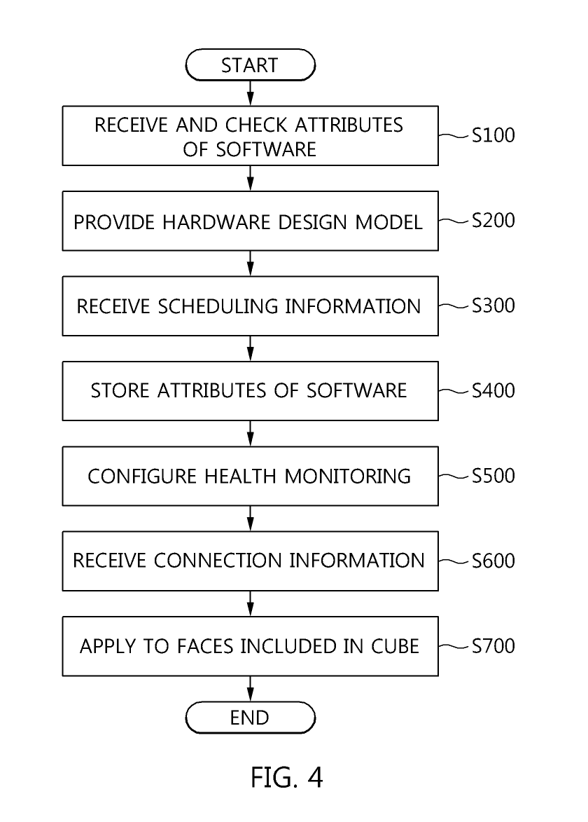

A method of providing a user interface regarding the aeronautical system configuration is described in detail below with reference to FIG. 4.

FIG. 4 is a flowchart illustrating the method of providing a user interface regarding the aeronautical system configuration in accordance with an embodiment of the present invention.

Referring to FIG. 4, the software architecture unit (110 of FIG. 1) receives or checks the basic attributes (e.g., corresponding to a name or an ID) of a module OS at step S100.

The hardware architecture unit (120 of FIG. 1) is a system architecture and is a hardware architecture, that is, a base for the operation of corresponding software. The hardware architecture unit (120 of FIG. 1) is not directly related to configurations included in the ARINC 653 standard, but it provides a hardware design model used in hardware/software-simultaneous designs and tests (e.g., simulations and pattern verification) at step S200.

The scheduling unit (130 of FIG. 1) receives information about the scheduling of partition information that belongs to configuration values included in the ARINC 653 standard and transforms the received information in a specific form that can be easily understood at step S300. Here, the scheduling information corresponds to information about the scheduling of partition information.

That is, the face 230 corresponding to the scheduling unit (130 of FIG. 1) does not list numbers corresponding to scheduling information, but may visualize and show the duration of each piece of partition information in width.

The memory unit (140 of FIG. 1) stores the elements of the software architecture unit 210, that is, the configurations of a module OS and partitions and the basic attributes of the partitions and the module at step S400. Here, the elements of the software architecture 210 may have number and GUI forms.

The health monitoring unit (150 of FIG. 1) configures health monitoring of a system/module level at step S500. Here, information corresponding to the health monitoring may be inputted or modified in a table form.

The connection unit (160 of FIG. 1) receives connection information regarding that partitions are connected to which channel and shows the received connection information in a GUI form at step S600.

Thereafter, in the method of providing a user interface regarding an aeronautical system configuration, the software architecture unit 110, the hardware architecture unit 120, the scheduling unit 130, the memory unit 140, the health monitoring unit 150, and the connection unit 160 are applied to the six faces of the cube, respectively, at step S700.

As described above, the user interface providing apparatus and method regarding an aeronautical system configuration in accordance with the embodiments of the present invention can increase understanding of a complicated aeronautical system and reduce the inconvenience of an aeronautical system configuration by providing a user interface of a cube form in which an integrator and a software developer can easily understand an aeronautical system configuration method.

The exemplary embodiments have been disclosed in the drawings and specification. Specific terms have been used herein, but the terms are used to only describe the present invention, but are not used to limit the meaning of the terms or the scope of the present invention written in the claim. Accordingly, those skilled in the art will understand that various modifications and other equivalent embodiments are possible from the present invention. Accordingly, the true technical scope of the present invention should be determined by the following claims.

What is claimed is:

1. An apparatus for providing a user interface used to input configuration values of an aeronautical system regarding an aeronautical system configuration, the apparatus comprising:
a software architecture unit configured to receive or check attributes of software applied to the aeronautical system;
a hardware architecture unit configured to provide a hardware design model that is a base for an operation of the software;
a scheduling unit configured to receive information about a scheduling of partition information that belongs to the configuration values and transform the scheduling information in a specific form;
a memory unit configured to store the attributes of the software;
a health monitoring unit configured to configure health monitoring based on the software architecture unit; and
a connection unit configured to receive connection information regarding that partitions are connected to which channel,
wherein the software architecture unit, the hardware architecture unit, the scheduling unit, the memory unit, the health monitoring unit, and the connection unit are applied to respective six faces included in a cube.

2. The apparatus of claim 1, wherein configuration values included in an Aeronautical Radio, Incorporated (ARINC) 653 standard are able to be inputted.

3. The apparatus of claim 1, wherein the software architecture unit distinguishes a specific partition when a user selects the specific partition through a touch or click.

4. The apparatus of claim 3, wherein faces other than a face corresponding to the software architecture unit change corresponding configuration values in accordance with the specific partition.

5. A method of providing a user interface used to input configuration values of an aeronautical system regarding an aeronautical system configuration, the method comprising:
receiving or checking, by a software architecture unit, attributes of software applied to the aeronautical system;
providing, by a hardware architecture unit, a hardware design model that is a base for an operation of the software;
receiving, by a scheduling unit, information about a scheduling of partition information that belongs to the configuration values and transforming the scheduling information in a specific form;
storing, by a memory unit, the attributes of the software;
configuring, by a health monitoring unit, health monitoring based on the software architecture unit; and
receiving, by a connection unit, connection information regarding that partitions are connected to which channel,
wherein the user interface is provided by applying the software architecture unit, the hardware architecture unit, the scheduling unit, the memory unit, the health monitoring unit, and the connection unit are applied to respective six faces included in a cube.

6. The method of claim 5, wherein configuration values included in an Aeronautical Radio, Incorporated (ARINC) 653 standard are able to be inputted.

7. The method of claim 5, wherein in the receiving or checking of the attributes of the software, a specific partition is distinguished when a user selects the specific partition by touching or clicking on a face corresponding to the software architecture unit in the cube.

8. The method of claim 7, wherein faces other than a face corresponding to the software architecture unit change corresponding configuration values in accordance with the specific partition.
